(19) United States
(12) Patent Application Publication
(10) Pub. No.: US 2009/0063028 A1
(43) Pub. Date: Mar. 5, 2009

(54) Engine flare management system and method

(75) Inventors: Ian Aitchison, Coventry (GB); Toyoji Yagi, Coventry (GB); Yasuhiro Nakai, Kariya-shi (JP)

Correspondence Address: NIXON & VANDERHYE, PC, 901 NORTH GLEBE ROAD, 11TH FLOOR, ARLINGTON, VA, 22203, US

(73) Assignee: DENSO Corporation, Kariya-city (JP)

(21) Appl. No.: 12/081,063

(22) Filed: Apr. 10, 2008

Related U.S. Application Data
(63) Continuation-in-part of application No. 11/892,811, filed on Aug. 27, 2007.

(51) Int. Cl. F02D 45/00

(52) U.S. Cl. 701/113

(57) ABSTRACT

A method of controlling an internal combustion engine during a start up phase, include cranking the internal combustion engine to initiate the start up phase and controlling an alternator load so as to increase load on the engine during at least a part of the start up phase, thereby to control engine speed flare and/or at least partially to recover energy used to start the internal combustion engine. Even when base ignition timing and/or fueling calibration for starting the engine is modified to improve combustion stability, the alternator load can be controlled to control engine speed flare and/or recover start energy.

### CROSS REFERENCE TO RELATED APPLICATION

This application is a continuation-in-part of application Ser. No. 11/892,811 filed Aug. 27, 2007, the entire content of which is incorporated by reference in this application.

### FIELD

Non-limiting example embodiments of the present invention relate to managing or controlling engine flare for an internal combustion engine.

### BACKGROUND

During a start up phase of an internal combustion engine, it is typical in the first few seconds for the engine revolutions to initially rise, before going back to a steady idle. This is known as flare. Flare results from a number of factors, but is related to the need to provide a higher quantity of fuel that is normally provided at idle to match the air trapped in the engine combustion chamber or chambers (e.g. the cylinder(s) of a cylinder-based engine) of an engine that has not recently been run (and may be relatively cold) in order to achieve a sufficiently rich mixture that will ignite. Once the engine fires up, this increased quantity of air/fuel mixture being provided to the combustion chamber, or chambers, causes the engine to accelerate rapidly. This causes flare, resulting in increased emissions, increased noise, and increased consumption with respect to the engine turning over at normal idle speed.

There is a need, therefore to better control, or to manage flare during an engine start up phase to mitigate these disadvantages.

### SUMMARY

An aspect of non-limiting example embodiments of the invention provides an engine management system comprising start up control logic operable during a start up phase of an internal combustion engine to control an alternator load so as to control engine speed flare.

By controlling the alternator load during at least a part of the start up phase, flare can be reduced, whereby savings on emissions, noise and fuel consumption can be achieved. Even when an engine ignition timing is advanced or an engine fueling increased in order to improve combustion stability, the flare speed can be reduced by controlling the alternator load during at least a part of the start up. That is, advancing the ignition timing (e.g., in a spark ignition engine) or increasing the fueling (e.g., in a diesel engine) will normally result in an increased flare speed. However, by controlling the alternator load in example embodiments of the invention, the flare speed can be controllably reduced. Benefits resulting from improved combustion stability as well as reduced engine speed flare can thus be achieved. Other benefits such as increased start energy recovery by the alternator can also be achieved.

Another aspect of non-limiting example embodiments of the invention provides an engine management system comprising start up control logic operable during a start up phase of an internal combustion engine to control an alternator load so that energy used in starting the engine can be at least partially recovered and stored in, for example, a vehicle battery.

An internal combustion engine, for example a spark ignition engine or a compression ignition engine can be provided with such an engine management system. Also, a vehicle can be provided that includes an internal combustion engine with such an engine management system.

Other aspects of non-limiting example embodiments of the invention include methods of operating such an engine management system and a computer program for carrying out the methods.

### BRIEF DESCRIPTION OF THE DRAWINGS

Non-limiting example embodiments of the present invention will now be described by way of example only with reference to the accompanying drawings.

FIG. 1 is a schematic representation of a vehicle including an internal combustion engine and an engine management system;

FIG. 2 is a schematic representation of an alternator;

FIG. 3 is a schematic block diagram illustrating control logic of an engine control unit for controlling an alternator;

FIG. 4 is an example torque control diagram;

FIG. 5 is an example illustrating the recovery of energy using an alternator for flare control;

FIG. 6 is a graph illustrating a regeneration ratio of energy using the alternator for flare control; and

FIG. 7 is a schematic block diagram illustrating different modes of operation of the engine control unit.

### DETAILED DESCRIPTION

Example embodiments of the invention are described in which an alternator is used to control flare and to recover energy in a start-up phase of an internal combustion engine.

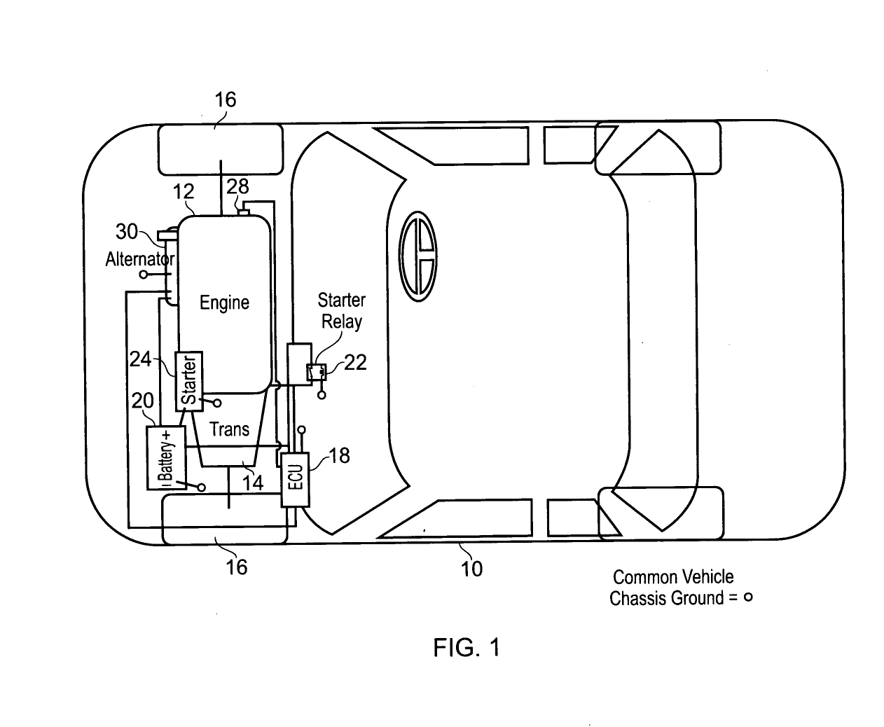

FIG. 1 is a schematic representation of a vehicle 10 including an internal combustion engine 12 and an engine management system including an engine control unit 18.

The engine 12 is connected to the driving wheels 16 of the vehicle via a transmission 14. In the present example, the vehicle is shown as being a front wheel drive vehicle. However, it will be appreciated that, in other embodiments, the present invention can be applied to rear wheel drive and all wheel drive vehicles.

A battery 20 is used for the storage of electrical energy within the vehicle system. In the present example, a single battery 20 is provided. However, in other example vehicles, more than one battery may be provided serving similar or different purposes. For example, the vehicle may be a hybrid vehicle and batteries may be provided for the storage of electrical energy for powering electric motors within the hybrid system.

An engine management system is provided that includes an engine control unit (ECU) 18. The ECU 18 can be a programmable ECU including, for example, one or more microcontrollers and/or microprocessors controlled by one or more control programs. The ECU 18 is connected to various sensors and control mechanisms to sense control parameters and to control the internal combustion engine systems. For example, the ECU 18 can be connected to receive a signal from a crank sensor 28 and to send and receive signals from an alternator 30. It will be appreciated that the ECU 18 can be connected to many more systems and sensors within the vehicle 10.

FIG. 1 illustrates a starter relay 22 which is activated when it is desired to start the internal combustion engine 12. The starter relay 22 may be activated manually by a user, for example by turning an ignition key or pressing a start button. In some embodiments, the starter relay can be activated automatically, for example in a hybrid vehicle where the internal combustion engine needs to be started. Activation of the starter relay 22 causes a starter 24 to draw power from the battery 20 in order to crank, or turn over, the engine 12.

Cranking the engine 12 by means of the starter 24, in combination with control signals from the ECU 18, causes a start up phase in engine control for the internal combustion 12, as will be described in more detail hereinafter. Also shown in FIG. 1 is the alternator 30 which is driven by the internal combustion engine 12 and is used to generate electrical energy for recharging the battery 20. The alternator can be under the control of the ECU 18 as will be described hereinafter.

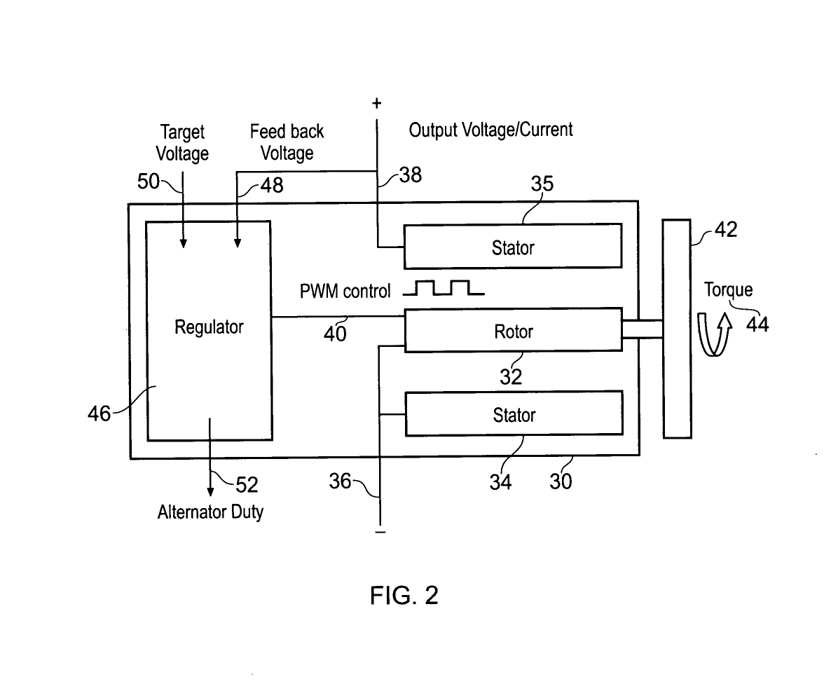

FIG. 2 is a schematic representation of an alternator 30. As shown in FIG. 2, the alternator includes a rotor 32 which is driven by a drive wheel 42 which is driven by the internal combustion engine 12, for example by a belt or chain, gearing or by a direct drive. Rotation of the rotor 32 in combination with the stators 34, 35 causes electrical energy to be generated which manifests itself by way of an output voltage and current between a ground terminal 36 and a positive output terminal 38 in a negatively grounded vehicle. The operation of the rotor can be controlled by a pulse width modulation (PWM) control signal 40 which is supplied from a regulator 46.

The alternator 30 shown in FIG. 2 further includes the regulator 46 which receives as a control input a target voltage signal 50 supplied from the ECU 18, and a feed back voltage 48 which corresponds to the output voltage 38 provided from the stator 35. The regulator 46 is responsive to the input signals to adjust the PWM control signal 40 so as to correct any discrepancy between the feed back voltage 48 and the target voltage 50. The regulator 46 also generates an alternator duty signal 52, which is representative of the duty cycle of the PWM control signal 40, and is supplied to the ECU 18. The rotation of the rotor 32 requires a torque 44 to be applied to the drive wheel 42. The amount of torque 44 which is required corresponds to an alternator load, which alternator load is a combination of internal friction within the alternator and the electromagnetic force exerted between the rotor 32 and the stators 34, 35. The alternator load can be controlled by means of the PWM control signal 40 as will be described hereinbelow.

As described in the introduction, during a startup phase of an internal combustion engine, a quantity of fuel is provided to the one or more combustion chambers of the internal combustion engine to match the air trapped in the engine combustion chamber(s). Effectively, at engine start up, an open throttle setting is used whereby a higher quantity of fuel is provided than would be needed at a steady state idle speed for the internal combustion engine. This initial amount of fuel is designed to enable a rapid initial acceleration of the engine.

However, the rapid acceleration of the engine typically causes the engine to accelerate beyond normal idle speed to create what is generally known as “flare”. Conventionally, the flare of an engine can be controlled by, for example, retarding the ignition timing in a spark ignition engine (e.g., a gasoline engine) and/or by retarding the fuel injection in a spark ignition engine such as a gasoline engine or a compression engine such as a diesel engine. However, retarding the ignition and/or fuel injection timing can lead to less efficient fuel burn and to potentially increased emissions during the start up phase of an internal combustion engine.

As described above, in a non-limiting example embodiment of the invention, the alternator load is used to control the load on the internal combustion engine which can be used to control flare and/or at least partially to recover energy used by the starter motor when starting the internal combustion engine.

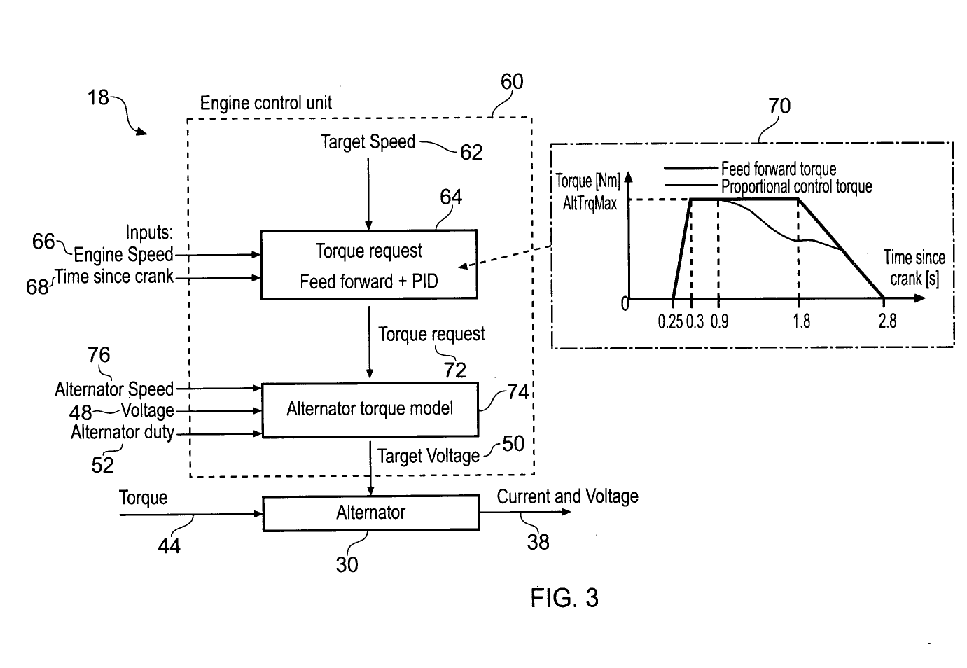

FIG. 3 is a schematic representation of a start up control unit 60 which forms part of the ECU 18 and is used to control the operation of the alternator in such a way as to control the alternator load applied to the internal combustion engine and therefore to control the flare. The start up phase control unit 60 is based on a methodology that aims to achieve a target speed 62 during the start up phase of the internal combustion engine. This start up speed is used as an input parameter to a torque request logic 64 that forms a torque request controller 64. The torque request logic 64 receives as inputs the target engine speed value 62, for example from parameter storage in the ECU 62, the current engine speed value 66, for example derived from signals from the crank sensor 28, and the time 68 since the initial crank, for example derived from a real time clock of the ECU 62.

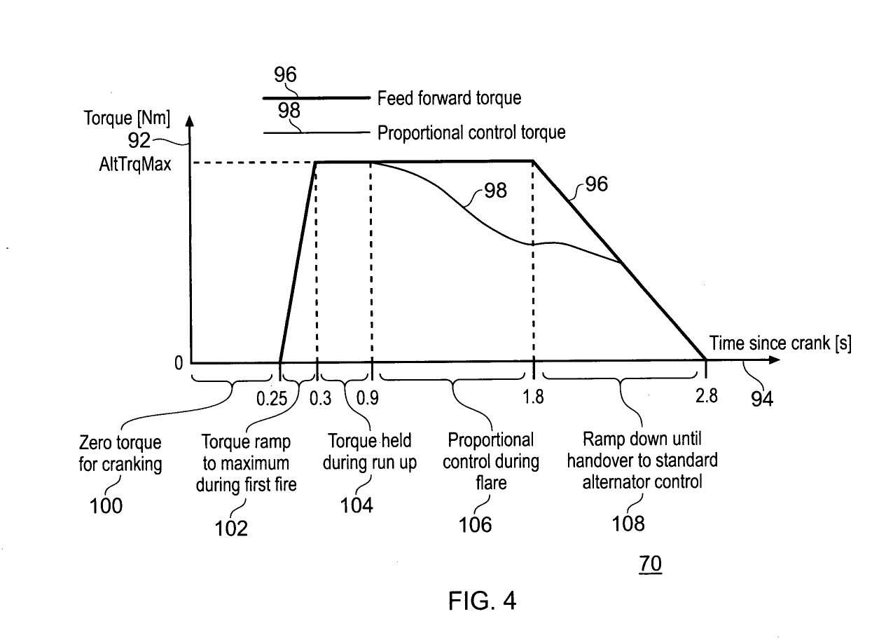

The torque request logic 64 contains a map providing a feed forward profile based on a time since cranking started (i.e., since the starting of the starter motor). The torque request logic 64 includes a feed forward profile based on time since cranking started as the response of the alternator is delayed from the request. The torque request profile 70 is represented in more detail in FIG. 4.

FIG. 4 represents a relationship between torque 92 and a time since crank (i.e., initial starter motor start). FIG. 4 illustrates a feed forward torque plot 96 and a proportional control torque plot 98. In this example, the feed forward torque plot 96 and the proportional control torque plot 98 are identical apart from the period of divergence illustrated in FIG. 4. As seen in FIG. 4, in an initial part 100 of the start up phase, a low torque (in the present example a substantially zero torque, that is a substantially zero alternator load, which equates to a zero alternator duty) is provided by the alternator to facilitate cranking of the engine and initial engine start.

In the present example, a second part 102 of the start up phase, after approximately 0.25 of a second, the torque is ramped up to an increased torque value, or alternator load, during the first firing of the engine. For example this could equate to a maximum 100% alternator duty, or some other duty value, for example an 80% or an 85% alternator duty).

In a third part 104 of the start up phase, between approximately 0.3 and 0.9 of a second in the present example, the torque, or alternator load is held at a constant value (for example the increased value mentioned above) during engine run up (i.e. as the engine runs up to a speed when it is self sustaining without the starter motor turning).

In the next, flare, part 106 of the start up phase, between approximately 0.9 and 1.8 seconds in the present example, proportional control of torque is provided. In this phase, the torque request logic 64 is responsive to at least the current engine speed and the target engine speed dynamically to determine feed forward values for generating a torque request signal used dynamically to control the alternator load.

In a final, handover, part 108 of the start up phase, between 1.8 and 2.8 seconds in the present example, torque is ramped down until handover to standard alternator control during normal operation of the engine. As illustrated in FIG. 4, during the handover phase 108, the feed forward torque request is ramped down after flare is complete. When the battery voltage falls below a calibrated threshold, the alternator can be switched back to normal engine management system control. This can enable a smooth torque and voltage delivery at the handover from flare control to engine management system control. In this regard, it should be noted that normal engine management system control delivers a target battery voltage, whereby the torque used and the alternator load can be calculated by the engine management system to allow throttle and ignition control to compensate for a reduction in brake torque available.

It should be understood that the timings illustrated in FIG. 4 are merely illustrative for one example of an internal combustion engine. The timings may vary depending on the type of engine (spark or compression ignition) and on many other factors such as the internal compression of the engine, the number of cylinders, etc.

Returning to FIG. 3, in an embodiment of the invention, the feed forward torque profile can be reduced by a proportional term based on engine speed error from a target speed. This profile can be used to correct alternator torque requests in response to the engine speed profile using a proportional-integral-derivative controller (PID controller) that forms part of the torque request logic 64. The PID controller provides a control loop feedback mechanism that attempts dynamically to correct the error between the measured engine speed value and the target engine speed value and adjusts the torque request signal in accordance with a stored process map. The PID controller calculation involves three separate parameters; the Proportional, the Integral and Derivative values. The Proportional value determines the reaction to the current error, the Integral determines the reaction based on the sum of recent errors and the Derivative determines the reaction to the rate at which the error has been changing. The weighted sum of these three actions is outputted as the torque request signal.

The output of the torque request logic 64 is a torque request signal 72 which is provided to alternator torque logic 74 that forms an alternator torque controller. The alternator torque logic 74 provides a mapping defining an alternator torque model which is used by the engine management system to deliver the target battery voltage in normal usage. However, by an inverse lookup of the alternator torque model, using the torque request signal 72 a target voltage signal 50 can be output that is provided to the alternator 30 to enable the regulator of the alternator to control the PWM control signal 40 and hence to control the torque 44, that is the alternator load, required.

The alternator torque model 74 receives as inputs the alternator speed 76 from an alternator speed sensor (not shown), the feedback voltage 48 from the stator 35 and the alternator duty 52 from the regulator 46.

The target voltage signal 50 can be supplied to the alternator 30 in any suitable manner, for example as an analog or digital signal as, for example, a voltage or current signal or through another communication bus. The target voltage is achieved by changing the duty cycle of the PWM control signal. If the PWM control signal 40 is permanently at high (i.e., 100 percent alternator duty) then maximum possible power (voltage×current) may be generated, whereby if the PWM control signal has, for example, a 50 percent duty cycle (i.e., is high for half the time providing 50% alternator duty), then a lower amount of power (voltage×current) is output by the alternator. If the PWM control signal 40 is low all of the time, this provides zero alternator duty. It should be noted with reference to FIG. 4, that the reference there to maximum torque value as maintained for example in the part 104 of the startup phase could be representative of, for example, less that a 100% duty cycle, for example 80% or 85% duty cycle providing 80% or 85% alternator duty respectively.

The PWM signal is controlled to prevent the system voltage from exceeding a safe operating limit. In a nominal 12V system this could, for example, be set at 15V. Increasing the voltage limit will allow the alternator to generate more power, but will require a DC/DC converter to supply a correct voltage to the vehicle systems.

In a vehicle system, the alternator is typically used to replace the power used when the engine is started, before the engine is next stopped, by, for example, recharging the battery during normal operation. However, an example embodiment of the present invention enables this power to be recovered more efficiently as a result of the flare control methodology described above.

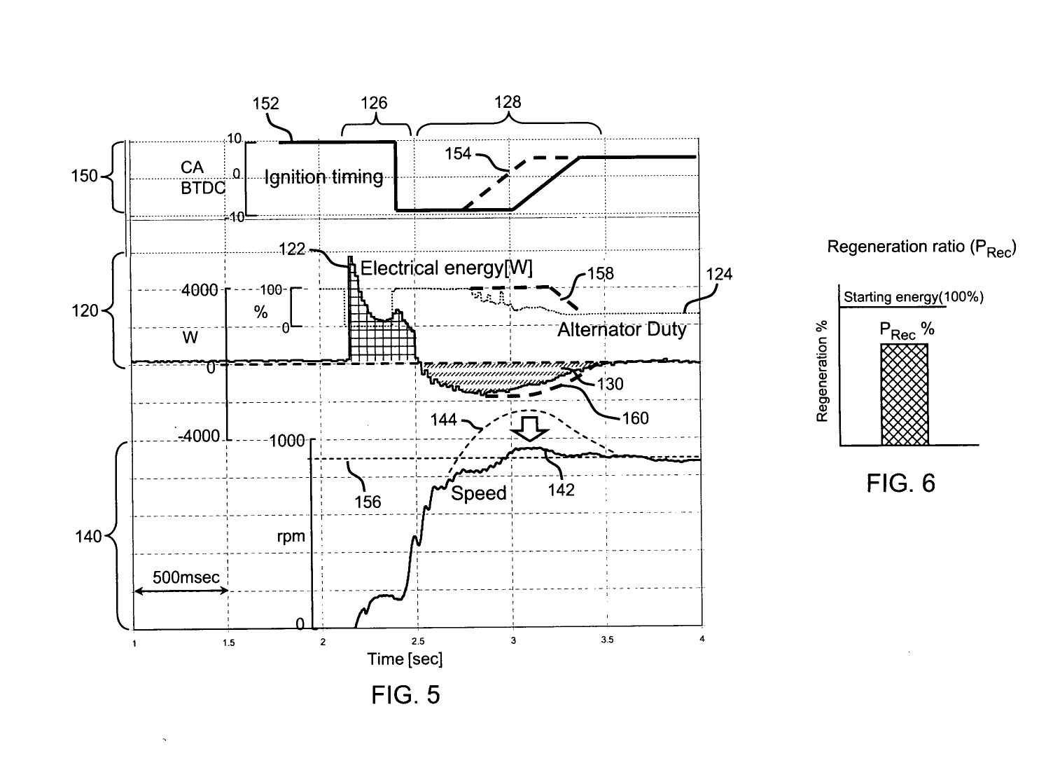

FIG. 5 illustrates the alternator power generated during engine start with flare control active. The effect that this has on the engine speed is illustrated. In particular, 120 represents a plot of an electrical energy (W) signal 122 during a start up phase of an internal combustion engine, and compares this to an alternator duty plot 124. As can be seen in FIG. 5, in an example of an embodiment of the invention, in a period 126, electrical energy is used in order to start the internal combustion engine. However, in a period 128, the use of the alternator loading can achieve a recovery of an amount of energy 130, which recovered energy is used to apply loads to the engine and to reduce the speed of the engine as it shown in section 140 of FIG. 5. Plot 142 represents an example of an actual engine speed with the alternator flare control in operation, and compares this to the engine speed 144 which would be expected without the alternator-controlled flare control.

Equations 1, 2 and 3 mathematically describe the ratio calculation illustrated in FIG. 5.

Equation 1 below defines the power used for starting the engine.

$${P}_{Start} = {\int }_{A} ( Voltage * Current ) \qquad Equation 1$$

Equation 2 below defines the power generated by the alternator and stored in the battery during flare control. The efficiency term is required as the conversion of electrical energy generated by the alternator to chemical energy in the battery is not 100 percent efficient.

$${P}_{Charge} = ( {\int }_{B} ( Voltage * - Current ) ) * Efficiency \qquad Equation 2$$

Equation 3 below calculates the regeneration ratio (percentage of power recovered) during each engine start.

$${P}_{Rec} = \frac{100}{{P}_{Start}} * {P}_{Charge} \qquad Equation 3$$

FIG. 6 illustrates an exemplary regeneration ratio of energy using the flare control methodology described above. It is predicted that a maximum alternator voltage of approximately 18.75V would allow all of the energy to be recovered during flare (regeneration ratio equals 100 percent), assuming a charge efficiency of 80%. In a vehicle with a nominal 12V supply, in order to achieve this without risk of damage to the electrical components, a DC/DC converter to supply the correct voltage to the vehicle systems could be employed.

It would be beneficial to improve the combustion stability of the internal combustion engine. Improving the combustion stability of the internal combustion engine will decrease the amount of harmful emissions from the engine. In order to achieve the benefit of improved combustion stability, the base ignition timing of the engine and/or amount of fueling to the engine may be modified. In particular, the ignition timing can be advanced and/or the amount of fueling (e.g., fuel provided to the engine through fuel injectors as controlled by the ECU 18) may be increased. While advancing the ignition timing (e.g., in a spark ignition engine) or increasing the fueling (e.g., in a diesel engine) would provide the benefit of improved combustion stability, it would also normally produce the disadvantage of an increased engine flare speed. As can be seen in FIG. 5, in an example embodiment of the invention, plot 150 represents an example of ignition timing 152 in a spark ignition engine, during a start up phase of an internal combustion engine. However, in a period 128, it is possible to advance the ignition timing 154 in order to increase the engine speed to a target level 156 (e.g. 900 rpm in the present example). By increasing the ignition timing 154 and/or the fueling to the engine, example embodiments of the present invention enable the alternator duty to be controlled as shown by dashed line 158 so that the engine flare speed can be controlled. An increase the alternator duty required to control the engine flare speed will increase the electrical energy as shown by dashed line 160 that can be recovered. The best of both worlds can thus be achieved. Namely, example embodiments of the present invention can achieve an improved combustion stability and associated benefits such as a lesser amount of harmful emissions, but without a corresponding increase in engine flare speed. Additionally, the amount of energy used in the start up process of the internal combustion engine that is recovered by the alternator 30 can be increased as shown by dashed line 160 by advancing ignition timing as shown by dashed line 154 and/or increasing engine fuelling and appropriately controlling the alternator load as shown by dashed line 158. Even further, the reduction in engine flare speed results in reduced noise.

As discussed above, the torque request controller 64 receives a speed of the engine as an input parameter 66. When the start up speed of the engine exceeds a target idle speed, the torque request controller 64 determines an alternator torque request 72 using PID control and the start up engine speed. This alternator torque request 72 is ultimately used by the alternator 30 to determine an increased alternator duty which in turn increases the alternator load and hence engine load during engine speed flare. The engine flare speed can thus be reduced.

The alternator torque model 74 receives the torque request 72 (feed forward and PID torque request) from the torque request controller 64. The engine management system uses an alternator torque model of the alternator torque logic 74 to output a target voltage signal 50 to the alternator 30. The alternator 30 may have a smaller pulley than usual, or greater gear reduction, to allow a higher torque at a low speed. The target voltage signal 50 provided to the alternator 30 enables the regulator 46 of the alternator 30 to control the alternator 30 through duty control of the PWM signal 40 to adjust torque. In particular, the duty of the PWM control signal 40 may be increased in the manner shown in signal 124 of FIG. 5 as the engine speed as represented by signal 66 exceeds a target idle speed. The increased alternator duty results in increased output power (i.e., increased vehicle voltage and current) from the alternator 30 and increased engine load. The controlled alternator duty may therefore increase the output power of the alternator 30 and the engine load during an engine speed flare. Accordingly, when the engine ignition timing is advanced and/or engine fueling increased, the increased alternator load resulting in increased power from the alternator 30 during the start up phase of the engine will reduce engine speed flare, and thus reduce noise. Advanced base ignition timing and/or increased fueling for starting is thus provided with associated benefits such as combustion stability and lower emissions, without an increase in flare speed via the alternator duty control to increase alternator and engine load.

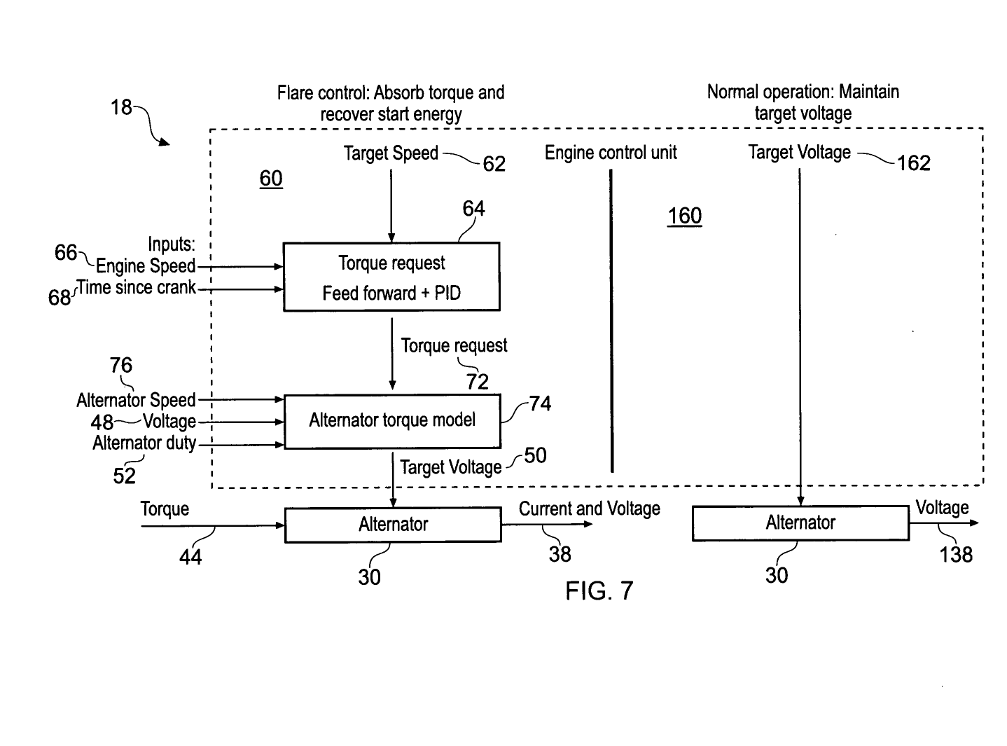

FIG. 7 is a schematic representation of two alternator control methodologies, as employed within the ECU 18. On the left hand side of FIG. 7, reference number 60 represents the engine start up control phase as described with reference to FIGS. 3-5 above, and the right hand side at reference number 160 describes normal alternator control whereby the PWM control signal is set in order to achieve a target voltage 162 without the employment of the torque request logic 64 and the alternator torque model 74 of the engine start up phase control logic.

There has been described an engine management system and a method for controlling an internal combustion engine during a start up phase, include cranking the internal combustion engine to initiate the start up phase and controlling an alternator load, which can be used dynamically adjust a load on the internal combustion engine during at least a part of the start up phase, thereby to control engine speed flare and/or to allow recovery of at least part of the energy used to start the internal combustion engine. The ignition timing for starting the engine can be advanced and/or the engine fueling can be increased in example embodiments of the present invention to obtain the benefit of increased combustion stability and lesser amount of harmful emissions, but without the normally countervailing disadvantage of increased flare speed. Moreover, advancing the ignition timing and/or increasing the fueling to improve combustion stability in example embodiments of the present invention enables an increased amount of energy used to start the internal combustion engine to be recovered.

An embodiment of the invention can also provide a computer program product in the form of a computer program for controlling the ECU of an engine management system to carry out such a method. The computer program can be provided on a carrier medium, for example a computer readable medium. The carrier medium could be a storage medium, such as a solid state, magnetic, optical, magneto-optical or other storage medium. The carrier medium could be a transmission medium such as broadcast, telephonic, computer network, wired, wireless, electrical, electromagnetic, optical or indeed any other transmission medium.

As indicated above, as well as enabling the control of engine flare, an embodiment the invention can enable the recovery of at least some of the electrical energy drawn from a battery by a starter motor to crank an internal combustion engine.

Also, as mentioned above, in prior internal combustion engine systems, ignition and/or fuel injection timings can be retarded to provide at least partial control of engine flare. An embodiment of the invention can enable the degree of ignition and/or fuel injection retardation to be reduced or eliminated, improving combustion and reducing fuel consumption, engine noise and environmental emissions.

Although the embodiments above have been described in considerable detail, numerous variations and modifications will become apparent to those skilled in the art once the above disclosure is fully appreciated. It is intended that the following claims be interpreted to embrace all such variations and modifications as well as their equivalents.

What is claimed is:

1. An engine management system comprising start up control logic operable during at least a part of a start up phase of an internal combustion engine to control an alternator load so as to control engine speed flare.

2. The engine management system of claim 1, wherein the start up control logic is operable to control the alternator load during said at least a part of the start up phase such that a power output of the alternator is increased.

3. The engine management system of claim 1, wherein the start up control logic is operable to control the alternator load during said at least a part of the start up phase such that energy used in starting the engine is at least partially recovered.

4. The engine management system of claim 1, wherein said at least a part of the start up phase is a flare part of the start up phase and the start up control logic is operable to control the alternator load dynamically during the flare part of the start up phase.

5. The engine management system of claim 4, wherein the start up control logic is operable to set the alternator load to at least one predetermined value during an initial part of the start up phase prior to the flare part of the start up phase.

6. The engine management system of claim 4, wherein the start up control logic is operable to set the alternator load to a lower value during a cranking part of the start up phase and to increase the alternator load during an initial combustion part of the start up phase prior to the flare part of the start up phase.

7. The engine management system of claim 6, wherein the lower value alternator load is a substantially zero level alternator load.

8. The engine management system of claim 6, wherein the start up control logic is operable between the initial combustion part of the start up phase and the flare part of the start up phase to maintain the alternator load at an increased value during an engine run up part of the start up phase.

9. The engine management system of claim 4, wherein the start control logic is operable after the flare part of the start up phase to ramp down the alternator load during a handover part of the start up phase prior to handing over standard control logic following controlling alternator load following the start up phase.

10. The engine management system of claim 1, wherein the control logic includes torque request logic operable to generate a torque request signal in response to a target speed value, a measured engine speed value and an elapsed time, the torque request signal being supplied to alternator torque control logic operable to determine a target alternator voltage signal for controlling the alternator load based on the torque request signal and alternator speed, alternator duty and alternator voltage values.

11. The engine management system of claim 1, wherein the start up control logic is further operable to modify an ignition timing such that combustion stability of the internal combustion engine is increased and to control the alternator load during said at least a part of the start up phase such that a power output of the alternator is increased so as to control the engine speed flare.

12. The engine management system of claim 11, wherein said modifying the ignition timing comprises advancing the ignition timing.

13. The engine management system of claim 1, wherein the start up control logic is further operable to modify an ignition timing such that combustion stability of the internal combustion engine is increased and to control the alternator load during said at least a part of the start up phase such that energy used in starting the engine is at least partially recovered.

14. The engine management system of claim 13, wherein said modifying the ignition timing comprises advancing the ignition timing.

15. The engine management system of claim 1, wherein the start up control logic is further operable to increase an engine fuelling such that combustion stability of the internal combustion engine is increased and to control the alternator load during said at least a part of the start up phase such that a power output of the alternator is increased so as to control the engine speed flare.

16. The engine management system of claim 1, wherein the start up control logic is further operable to increase an engine fuelling such that combustion stability of the internal combustion engine is increased and to control the alternator load during said at least a part of the start up phase such that energy used in starting the engine is at least partially recovered.

17. An engine management system comprising start up control logic operable during at least a part of a start up phase of an internal combustion engine to control an alternator load so as at least partially to recover energy used in starting the engine.

18. The engine management system of claim 17, wherein the start up control logic is further operable to advance an ignition timing such that combustion stability of the internal combustion engine is increased and wherein the control of the alternator load during said at least a part of the start up phase comprises increasing a power output of the alternator during said at least a part of the start up phase such that energy used in starting the engine is at least partially recovered.

19. The engine management system of claim 17, wherein the start up control logic is further operable to increase an engine fuelling such that combustion stability of the internal combustion engine is increased and wherein the control of the alternator load during said at least a part of the start up phase comprises increasing a power output of the alternator during said at least a part of the start up phase such that energy used in starting the engine is at least partially recovered.

20. An internal combustion engine system comprising:
an internal combustion engine; and
an engine management system comprising start up control logic operable during at least a part of a start up phase of an internal combustion engine to control an alternator load so as to control engine speed flare.

21. The internal combustion engine system of claim 20, wherein the start up control logic is further operable to advance an ignition timing such that combustion stability of the internal combustion engine is increased and wherein the control of the alternator load during said at least a part of the start up phase comprises increasing a power output of the alternator so as to control the engine speed flare.

22. The internal combustion engine system of claim 20, wherein the start up control logic is further operable to increase an engine fuelling such that combustion stability of the internal combustion engine is increased and wherein the control of the alternator load during said at least a part of the start up phase comprises increasing a power output of the alternator so as to control the engine speed flare.

23. A method of controlling an internal combustion engine during at least a part of a start up phase, the method comprising:
cranking the internal combustion engine to initiate the start up phase; and
controlling an alternator load so as to control engine speed flare.

24. The method of claim 23, comprising controlling the alternator load during said at least a part of the start up phase such that a power output of the alternator is increased.

25. The method of claim 23, comprising controlling the alternator load during said at least a part of the start up phase such that energy used in starting the engine is at least partially recovered.

26. The method of claim 23, wherein said at least a part of the start up phase is a flare part of the start up phase and the alternator load is controlled dynamically during the flare part of the start up phase.

27. The method of claim 26, further comprising setting the alternator load to at least one predetermined value during an initial part of the start up phase prior to the flare part of the start up phase.

28. The method of claim 26, further comprising setting the alternator load to a lower value during a cranking part of the start up phase and increasing the alternator load during an initial combustion part of the start up phase prior to the flare part of the start up phase.

29. The method of claim 28, wherein the lower value of the alternator load is a substantially zero level alternator load.

30. The method of claim 28, further comprising, between the initial combustion part of the start up phase and the flare part of the start up phase, maintaining the alternator load at an increased value during an engine run up part of the start up phase.

31. The method of claim 26, further comprising, after the flare part of the start up phase, ramping down the alternator load during a handover part of the start up phase prior to handing over standard control logic following controlling alternator load following the start up phase.

32. The method of claim 23, further comprising generating a torque request signal in response to a target speed value, a measured engine speed value and an elapsed time, and determining a target alternator voltage signal for controlling the alternator load based on the torque request signal and alternator speed, alternator duty and alternator voltage values.

33. The method of claim 23, further comprising modifying an ignition timing such that combustion stability of the internal combustion engine is increased and wherein said controlling the alternator load comprises increasing a power output of the alternator so as to control the engine speed flare.

34. The method of claim 33, wherein the ignition timing is advanced to increase the combustion stability.

35. The method of claim 23, further comprising modifying an ignition timing such that combustion stability of the internal combustion engine is increased and wherein the alternator load is controlled during said at least a part of the start up phase such that energy used in starting the engine is at least partially recovered.

36. The method of claim 35, wherein the ignition timing is advanced to increase the combustion stability.

37. The method of claim 23, further comprising increasing an engine fuelling such that combustion stability is increased and wherein said controlling the alternator load comprises increasing a power output of the alternator so as to control the engine speed flare.

38. The method of claim 23, further comprising increasing an engine fuelling such that combustion stability is increased and wherein the alternator load is controlled during said at least a part of the start up phase such that energy used in starting the engine is at least partially recovered.

39. A method of controlling an internal combustion engine during a start up phase the method comprising:
cranking the internal combustion engine to initiate the start up phase; and
controlling an alternator load so as at least partially to recover energy used in starting the engine.

40. The method of claim 39, further comprising advancing an ignition timing such that combustion stability of the internal combustion engine is increased and wherein the controlling of the alternator load comprises increasing a power output of the alternator during said at least a part of the start up phase so as to control the engine speed flare.

41. The method of claim 39, further comprising increasing an engine fuelling such that combustion stability of the internal combustion engine is increased and wherein the controlling of the alternator load comprises increasing a power output of the alternator during said at least a part of the start up phase so as to control the engine speed flare.
